(19) United States
(12) Patent Application Publication
(10) Pub. No.: US 2010/0000801 A1
(43) Pub. Date: Jan. 7, 2010

(54) SYSTEM AND METHOD FOR PROVIDING RECIPES ON A SCALE

(75) Inventors: Richard E. Smith, Raleigh, NC (US); Brian Hipsher, Worthington, OH (US); Kevin A. Russo, Lewis Center, OH (US); Ronald W. Tamkin, Pataskala, OH (US); Frank Beurskens, Buffalo, NY (US)

Correspondence Address: STANDLEY LAW GROUP LLP, 6300 Riverside Drive, Dublin, OH, 43017, US

(73) Assignee: METTLER-TOLEDO, INC., Columbus, OH (US)

(21) Appl. No.: 12/167,089

(22) Filed: Jul. 2, 2008

(51) Int. Cl. G01G 19/40; G01G 23/00

(52) U.S. Cl. 177/25.15; 177/245

(57) ABSTRACT

A weighing scale adapted to automatically present one or more recipes to a user thereof, and a method of presenting such recipes. The recipes are preferably, but not necessarily, related in some way to a product being weighed or otherwise examined by the weighing scale. A recipe software application selects one or more recipes from a database of recipes and presents the recipes on one or more display devices of the weighing scale. One or more of the presented recipes may be selected by a user for delivery in one or more forms. Recipes may be delivered to a user according to the present invention, by one or more of providing the user with a printout of the selected recipe(s), by emailing the selected recipe(s) to a user, and/or by providing the user with a website URL from which the selected recipe(s) can be downloaded.

### BACKGROUND OF THE INVENTIVE FIELD

The present invention is directed to the presentation of recipes on a weighing scale. More particularly, the present invention is directed to a system and method of automatically providing one or more recipes on a weighing scale, the recipes preferably related to an item being weighed or otherwise examined by the scale.

Historically, scales have been designed and used only to determine the weights of various items. The development of more advanced scales has allowed scale companies to offer features and functionality beyond the ability to weigh items, especially in the area of retail scales. These scales add value to the scale itself and when used in a retail environment, can support interaction not only with the store personnel but with customers as well. As a result, there is a desire to leverage the scale asset in new ways.

One way to increase the features and functionality of an advanced weighing scale is to run applications on the scale that are operative to provide a customer with information of interest and/or to incentivize the customer to purchase additional products. It is believed that automatically displaying one or more recipes on a weighing scale concurrently with the weighing or some other examination of a product will be of interest to a customer, and may motivate customers to shop in stores having such scales and/or incentivize customers to purchase additional ingredients called for by the recipe(s) and/or other products that may or may not be associated with the recipe(s).

Applications currently exist that are capable of displaying a variety of recipes related to a particular ingredient(s). For example, there are many websites that provide searchable databases dedicated to such tasks. There also exist in-store kiosks that may be equipped with a PC, a display, and a keyboard or other input means that allows a customer to receive one or more recipes upon entering some type of product (ingredient) identifier. However, to the inventors' knowledge, these kiosks are all standalone devices that are often remotely located within a store and must be deliberately sought out by a customer. That is, the use of kiosks requires that a customer actively seek out a recipe and the means for providing said recipe.

To date, there has not been an in-store recipe presentation mechanism that automatically displays recipes to a customer. Rather, current in-store mechanisms for displaying recipes to a customer generally require the customer to seek out the recipe displaying mecahnism and to specifically and intentionally invoke a recipe display. Therefore, there is a need for a recipe display mechanism that presents recipes to a customer automatically, at an opportune time, and in a convenient location. The present invention satisfies these needs.

### SUMMARY OF THE GENERAL INVENTIVE CONCEPT

A system and method of the present invention is operative to present one or more recipes on a display portion of an advanced weighing scale, without any deliberate interaction on the part of a customer. Rather, the presentation of such recipes preferably occurs automatically and substantially contemporaneously with the weighing and/or other examination of a product by the scale. For example, one or more recipes may be automatically displayed to a customer when a product PLU or SKU is entered into the scale, when a product barcode is scanned, or when any of various other product identifying information is provided to or detected by the scale.

Preferably, but not necessarily, the recipe(s) displayed on the scale are in some way related to the product currently being weighed or otherwise examined by the scale. For example, the product may be an ingredient in one or more of the recipe(s) displayed. One or more of the recipe(s) may also be related to the product as a complimentary side dish or main dish. For example, if the product is a meat, one or more of the recipe(s) displayed by the scale may be related to a side dish that is considered to be complimentary to the particular meat product. Alternatively, if the product is a vegetable, fruit, etc., one or more of the recipe(s) displayed on the scale may be related to a main dish that may be complimented by the the particular vegetable or fruit. It is also possible to display one or more recipes that are unrelated to the product being weighed or otherwise examined by the scale. Various combinations of recipe types may be displayed on the scale.

It may be the case that there are more relevant recipes available than can be simultaneously displayed on the scale. As such, in certain embodiments of the present invention, a customer may be permitted to scroll or otherwise search through a number of relevant recipes by interacting with one or more buttons, a touchscreen display, or other input mechanisms on, or associated with, the weighing scale. In other embodiments, the recipe display may automatically update to show other available recipes without any required interaction on the part of the customer. In still other embodiments, a change in the display of recipes may be initiated by a store employee.

Preferably, when a customer is presented with a recipe of interest, the recipe of interest may be made available to the customer in one or more forms. In one embodiment, the customer may obtain a printed form of the recipe, such as by interacting with the scale in some indicated manner or by requesting a printout from a store employee. In such a case, the recipe may print on a local printer in communication with the scale, on a remote printer in communication with the scale, or on a printer integral to the scale, such as on a label printer.

In another embodiment of the present invention, a recipe(s) may be transmitted to a customer's e-mail account. In this case, the customer may enter an e-mail address into the scale or may provide an e-mail address to a store employee. E-mail account information may also be provided via a customer card associated with the store and scanned by the scale or another device associated with the scale. A recipe may be e-mailed to a customer instead of, or in conjunction with, providing the customer with a printed recipe. In yet another embodiment, a customer may be directed to a website URL related to a recipe(s).

Advanced weighing scales typically have a scale software application (scale application) that governs their operation and remains in control of associated components to ensure that applicable legal for commerce restrictions are not violated. A recipe-displaying application of the present invention may be integral to the scale application. Alternatively, a recipe-displaying application of the present invention may be a secondary application that interacts with the scale application. In the latter case, the scale application may control the secondary recipe-displaying application in various ways, such as when the secondary application may run, where on the scale display the recipes may appear, etc.

### BRIEF DESCRIPTION OF THE DRAWINGS

In addition to the features mentioned above, other aspects of the present invention will be readily apparent from the following descriptions of the drawings and exemplary embodiments, wherein like reference numerals across the several views refer to identical or equivalent features, and wherein:

FIGS. 1a and 1b are perspective and rear views, respectively, of one exemplary embodiment of a typical advanced weighing scale;

FIG. 2 is a perspective view of an alternate exemplary embodiment of a typical advanced weighing scale;

FIG. 3 is illustrative of one embodiment of an initial screen that may appear on one or more display portions of an advanced weighing scale;

FIG. 4 is illustrative of one embodiment of a typical product category screen that may appear on one or more display portions of an advanced weighing scale;

FIG. 5 is illustrative of one embodiment of a typical product-specific screen that may appear on one or more display portions of an advanced weighing scale after product identifying information is entered into or detected by the scale;

FIG. 6 is illustrative of an alternate embodiment of a typical product-specific screen that may appear on one or more display portions of an advanced weighing scale after product identifying information is entered into or detected by the scale;

FIG. 7 graphically represents the operation of an exemplary embodiment of the present invention;

FIG. 8 depicts the screen of FIG. 5 as modified by one exemplary embodiment of the present invention to display a number of recipes;

FIG. 9 depicts the screen of FIG. 6 as modified by one exemplary embodiment of the present invention to display a number of recipes;

FIG. 10 illustrates an exemplary detailed recipe screen that may be presented on one or more display portions of an advanced weighing scale; and

FIG. 11 depicts an exemplary printout of a recipe obtained according to the present invention after viewing and selection on an advanced weighing scale.

### DETAILED DESCRIPTION OF EXEMPLARY EMBODIMENT(S)

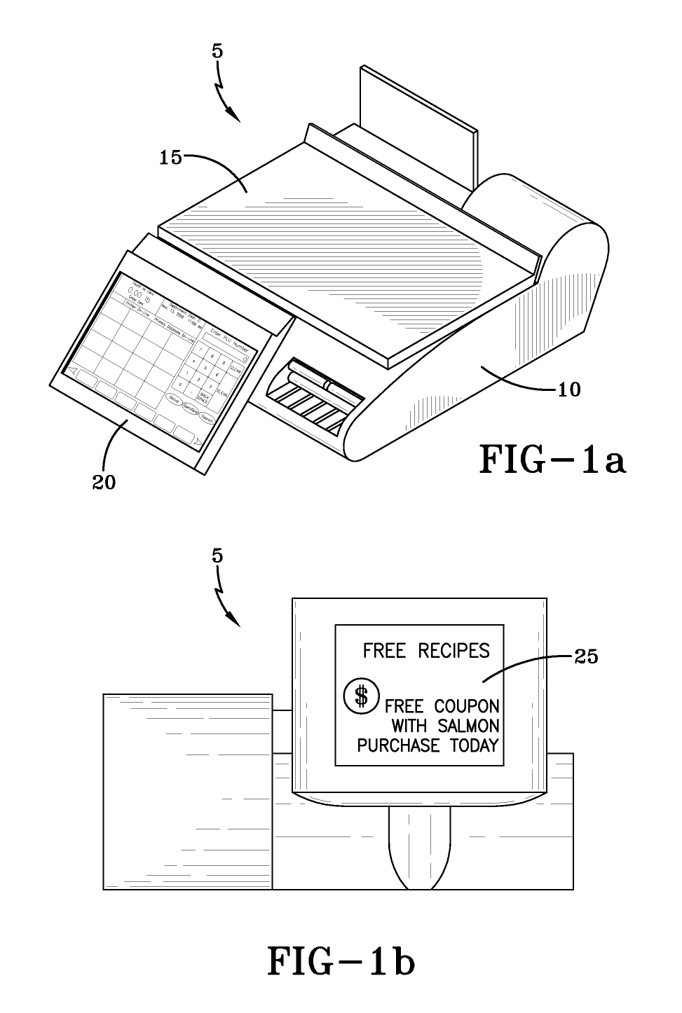

One exemplary embodiment of an advanced weighing scale (scale) 5 can be observed by reference to FIGS. 1a-1b. As shown, the scale 5 includes a body portion 10, and a weigh pan 15 that rests upon one or more subjacent load cells (not visible). Advanced weighing scales typically also include a microprocessor, an operating system (scale software application), memory, one or more displays, and an input means. Such scales may also include wired or wireless networking ability and/or a label printer. The display screen(s) of such a scale may be a touch screen.

The particular scale 5 depicted in FIGS. 1a-1b is designed for use by a store employee, such as in a deli department thereof. Such a scale will be generically referred to herein as a “counter service scale”, said reference used herein only as a generic descriptor and not as an indication of any requisite scale design, construction, operation and or location of use. The counter service scale 5 is provided with two displays 20, 25. In use, the counter service scale 5 is generally positioned on a counter or other surface, such that a primary display 20 will face the employee while the secondary display 25 faces a customer.

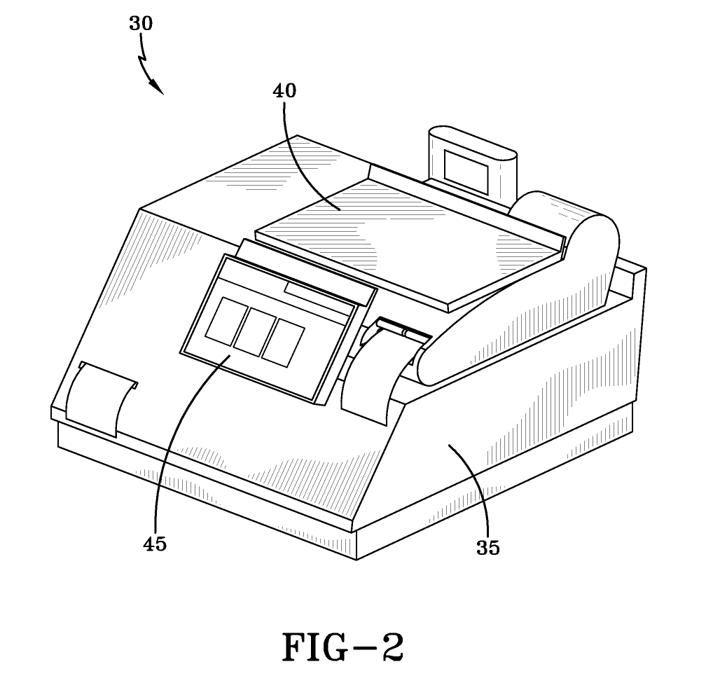

Other embodiments of advanced weighing scales are also possible. One such embodiment is illustrated in FIG. 2. As shown, this embodiment 30 again includes a body portion 35, and a weigh pan 40 that rests upon one or more subjacent load cells (not visible). Like other advanced weighing scales 5, this scale 30 will generally include a microprocessor, an operating system (scale software application), memory and an input means, and may also include wired or wireless networking ability and/or a label printer. In this embodiment of the scale 30, however, only one primary display 45 is present. The display screens of such a scale may be a touch screen.

Such a single display scale 30 may be placed at various locations within a store for use by customers, such as in a produce department. Such a customer-oriented scale will be generically referred to herein as a “self-service scale”, said reference used herein only as a generic descriptor and not as an indication of any requisite scale design, construction, operation and or location of use.

The various detailed constructions and features of such advanced weighing scales 5, 30 would be quite familiar to one skilled in the art and, consequently, no further description is required herein. One skilled in the art would also understand that the advanced weighing scales 5, 30 of FIGS. 1a-1b and FIG. 2 are merely exemplary embodiments of such scales, and various other designs may exist and be used in conjunction with the present invention.

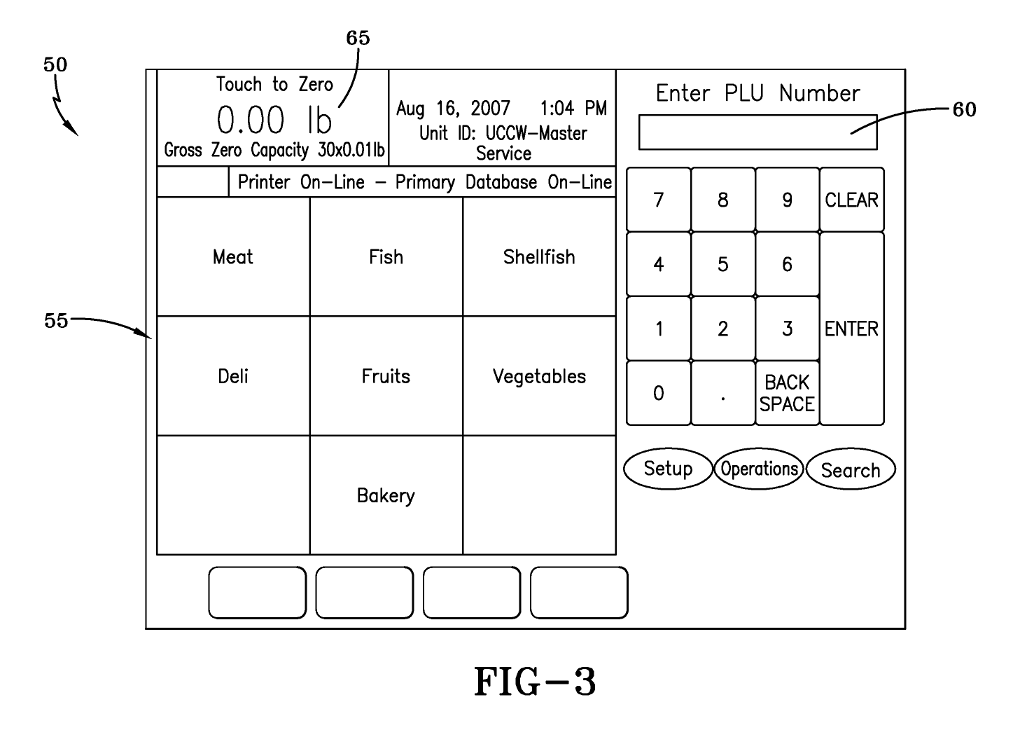

One exemplary embodiment of an initial display screen 50 that may appear on a display of an advanced weighing scale is shown in FIG. 3. Such a display screen 50 may appear, for example, on an employee display screen of a counter service scale, or the display screen of a self-service scale. Generally, such an initial display screen offers various product categories 55 (e.g., meat, fish, deli, fruits, vegetables, bakery) for selection and may provide an area 60 for entry of a product price look-up (PLU) code, stock keeping unit (SKU) code, and/or some other product identifying information. A product weight display area 65 and/or various other information may also be presented. As would be obvious to one skilled in the art, such screens may be infinitely variable as to their general appearance and/or to the information displayed thereon. Therefore, it is to be understood that the particular display screen shown in FIG. 3 is provided for purposes of illustration only.

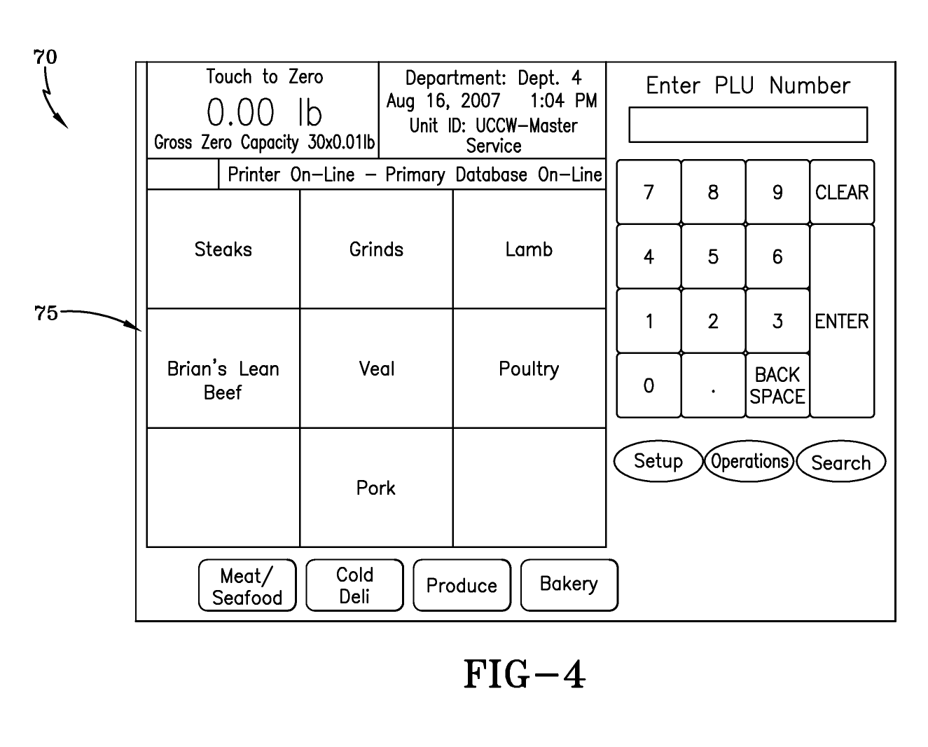

Another embodiment of an initial display screen 70 of the present invention is shown in FIG. 4. When, for example, a scale of the present invention is located in a particular department of a retail location (e.g., meat department, produce department), it may be desirable to provide a department-specific product category display screen 70 as the initial display screen. In this particular case, the exemplary product category initial display screen 70 displays a variety of different meats 75. Such an initial display screen could obviously instead display a variety of different fruits, vegetables, baked goods and/or other items. A product category initial display screen of the present invention may also display the same or similar information as described and shown with respect to the initial display screen 50 of FIG. 3 (e.g., an area for entry of a PLU or SKU code, a product weight display area, and/or various other information).

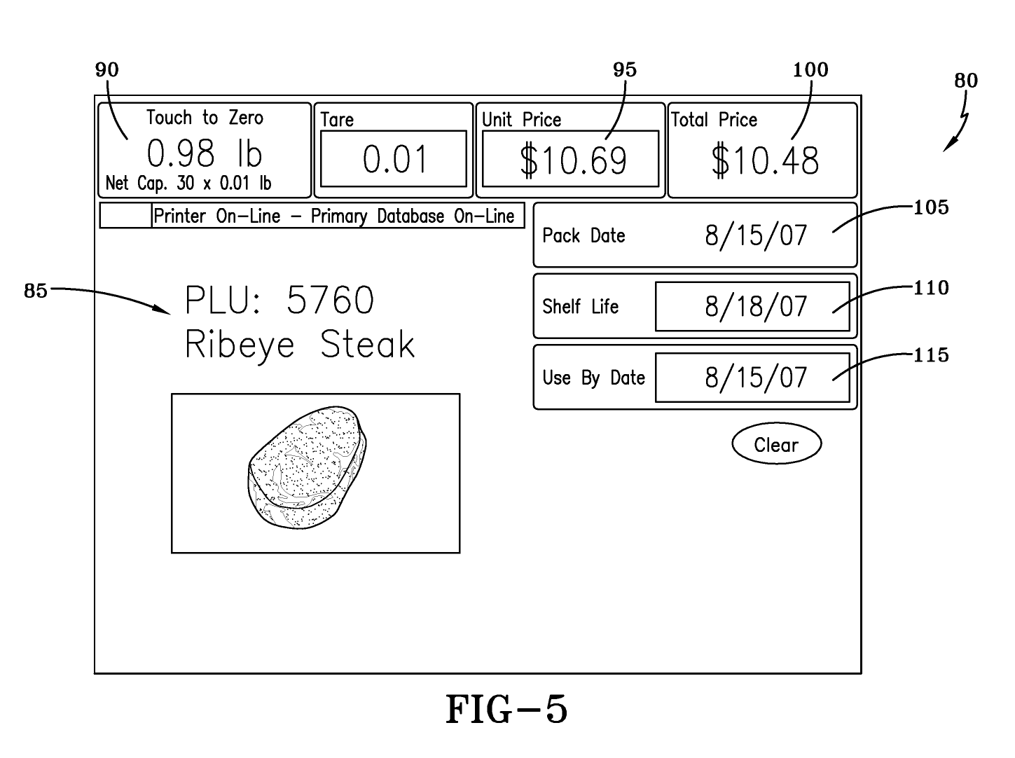

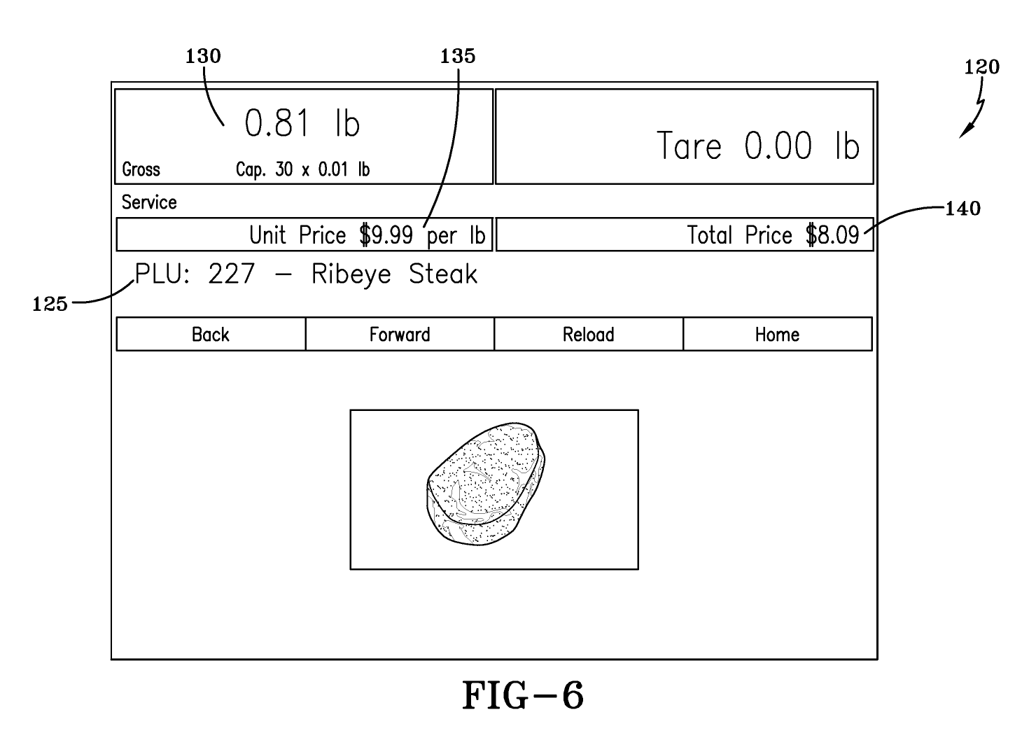

In any event, once a PLU code, SKU code or other product identifying information is input to the scale, a display screen similar to that shown in FIG. 5 or FIG. 6 typically presents additional information about the product. In the particular exemplary product-specific display screen 80 shown in FIG. 5, this information includes an identification of the product 85, the weight of the product 90, the unit price of the product 95, the total price of the product 100, and information regarding the pack date 105, use by date 110 and shelf life 115 of the product. A screen like that of FIG. 5 may be displayed to an employee or a customer. However, it is more likely that such a screen will be viewable only by an employee, as information such as the pack date, shelf life and use by date are not generally presented to a customer (although such is possible).

A customer is more likely to be presented with a product-specific display screen 120 like that shown in FIG. 6. That is, a customer is more likely to be presented with a product-specific display screen that includes an identification of the product 125, the weight of the product 130, the unit price of the product 135, and the total price of the product 140, but does not include pack date, use by date, shelf life or similar information. Consequently, a product-specific display screen 120 like that of FIG. 6 may commonly appear on the secondary display of a counter service scale or on the primary display of a self-service scale.

Obviously, the display screens of FIG. 5 and FIG. 6, like other screens presented for purposes of illustration herein, can vary considerably in appearance and information presented, and nothing herein is to be considered as limiting the scope of the present invention to the appearance or information shown therein. According to the present invention, and as explained in greater detail below, recipes may be presented on a display screen like that of FIG. 5 or FIG. 6, or on virtually any other display screen.

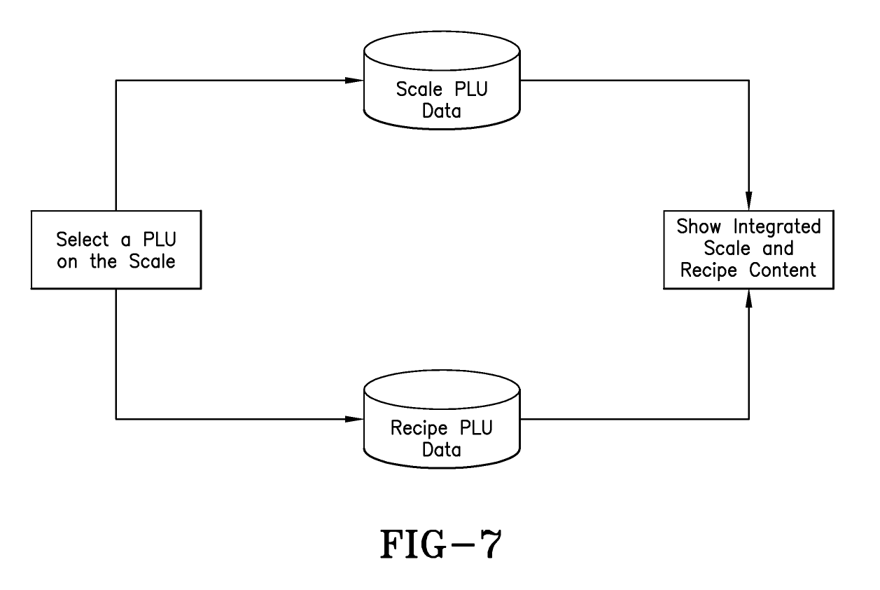

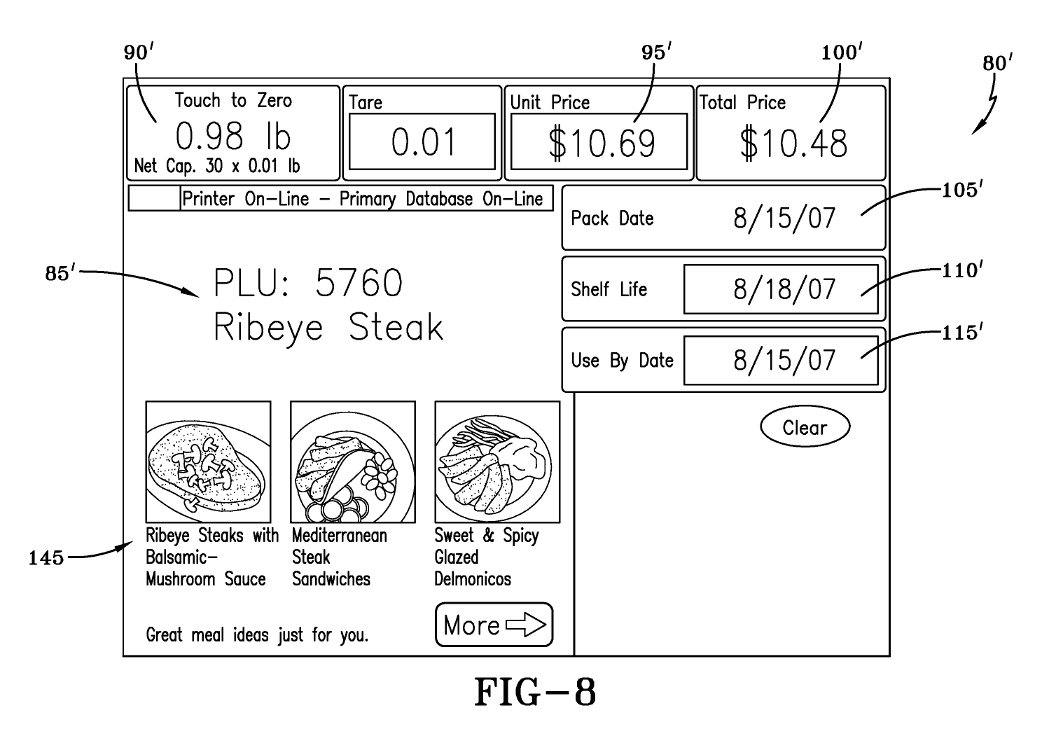

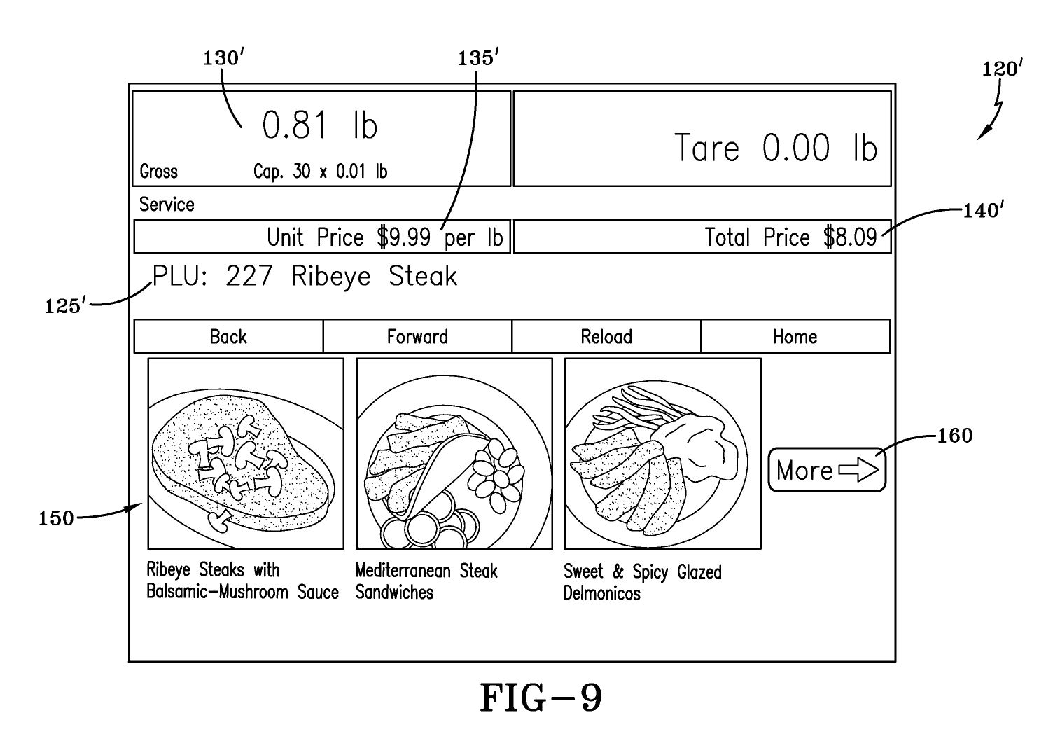

As graphically represented in FIG. 7, a system and method of the present invention is operative to present one or more recipes along with other product information on one or more display screens of an advanced weighing scale. No customer action is required to produce the initial display of recipes on the scale. Rather, the presentation of such recipes preferably occurs automatically and concurrently with the overall product selection and weighing and/or other examination of the product by the scale. For example, and as illustrated in FIGS. 8-9, one or more relevant recipes may be automatically displayed when a PLU code or SKU code is entered into the scale, when a product barcode is scanned, or when any of various other product identifying information is provided to or detected by the scale.

For purposes of illustration, FIG. 8 depicts a product-specific display screen 80′ that is essentially the same as the display screen 80 of FIG. 5, but modified according to one exemplary embodiment of the present invention to show a number of product-related recipes 145. Similarly, FIG. 9 depicts a product-specific display screen 120′ that is essentially the same as the display screen 120 of FIG. 6, but modified according to one exemplary embodiment of the present invention to show a number of product-related recipes 150.

As shown in the exemplary display screens 80′, 120′ of FIGS. 8-9, a number of recipes 145, 150 are presented that relate to a product placed on or otherwise identified to/by the scale (i.e., that relate to the product identifying information provided to or obtained by the scale). In this particular example the product is a ribeye steak, and the recipes 145, 150 shown are related to ribeye steak. More particularly, the recipes 145, 150 depicted in FIGS. 8-9 each include, or may include, ribeye steak as an ingredient.

As an alternative to, or in conjunction with, recipes that include the product of interest as an ingredient, the present invention may also present recipes that are related in some other way to the product of interest. For example, one or more presented recipes may be related to the product as a complimentary side dish or as a complimentary main dish. That is, if the product is generally a component of a main dish, one or more recipes displayed on the scale may be related to a side dish that is considered to be complimentary to the particular main dish. Alternatively, if a product of interest is generally considered to be a side dish, a dessert, etc., one or more main dish recipes may be displayed on the scale. Various combinations of recipe types may be displayed on the scale. In such a case, the various recipe types may be intermixed, or may be presented in searchable categories.

In yet another embodiment, a scale of the present invention may present one or more recipes that are unrelated to the product of interest. Such recipes may be selected by random, or may be selected by any other desired method. In such a case, the recipe presentation may include only unrelated recipes, or unrelated recipes may displayed along with recipes somehow related to the product of interest.

As can be understood from an observation of FIGS. 8-9, more recipes may be available than can be simultaneously displayed on the scale display. As such, a customer may be permitted to scroll or otherwise search through a number of relevant recipes by interacting with one or more buttons or other input mechanisms on, or associated with, the scale. With particular reference to FIGS. 8-9, this may be accomplished by touching the “More” button 155, 160 on the touchscreen of the scale. However, in other embodiments, recipe selection may also occur via a mouse or another input device familiar to those of skill in the art. The present invention is not limited to a particular input device. If/when the end of the available recipes is reached, a “Back”, “Return” or some other similar button (not shown) may appear, or the recipe display may automatically return to the beginning of the recipe list.

In other embodiments of the present invention, the recipe display may automatically and periodically update to show other available recipes without any required interaction on the part of the customer or an employee. In still other embodiments, a change in the display of recipes may be caused by a store employee, whether on the initiative of the employee or upon the request of the customer.

Once a customer observes a recipe of interest, the recipe may be selected. Recipe selection may occur by some direct interaction of the customer with the scale (e.g., by touching a recipe of interest while it appears on a touchscreen of the scale), or by some interaction of an employee with the scale upon request of the customer. Any input device/method known to those skilled in the art may be used for this purpose. In any event, upon selection, the recipe is preferably, but not necessarily, presented to the customer in more detail.

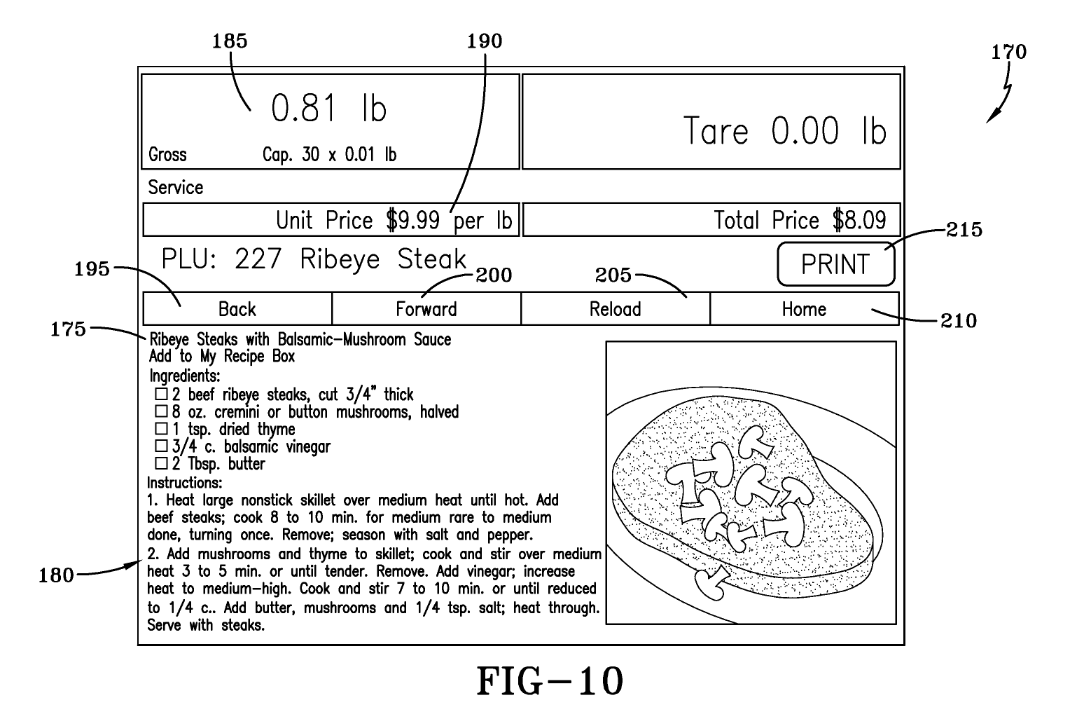

For example, and as illustrated in FIG. 10, a selected recipe 175 may be presented in greater detail on a separate recipe detail screen 170. In this particular example, additional information 180 regarding other required ingredients and preparation of the recipe are presented, and product weight 185 and price information 190 continues to be displayed in conjunction with the recipe details. Although optional, the weight and/or price information may assist a customer in deciding whether the recipe is truly of interest and, if so, whether a sufficient quantity of the product has been selected. Obviously, as with other screens presented according to the present invention, this recipe detail screen 170 may vary considerable in content and/or appearance, and all such variations are considered to be within the scope of the present invention.

Navigation buttons or other input means for allowing a user to return to a a previous or following recipe 195, 200, to a previous recipe-related display screen 205 and/or to a previous nonrecipe-related display screen 210 may be provided on the recipe detail screen. Such navigation means may allow a customer to move between recipe detail screens, to return to a recipe list, to return to a non-recipe screen, etc.

Preferably, a customer may select multiple recipes of interest, whether individually or collectively. In the former case, each recipe may be (optionally) viewed on a recipe detail screen, as described above and, if desired, printed or otherwise provided to the customer in a useable format on an individual basis. In the latter case, a customer may be permitted to select multiple recipes of interest, which recipes may be temporarily saved in a group. In this case, the group of recipes may (optionally) be made available for detailed viewing, whether on a single display screen or on separate display screens that may be selected by various techniques (such as by scrolling). A group of finally selected recipes may then be individually or collectively printed or otherwise provided to the customer in a useable format.

As mentioned above, once selected, a recipe(s) of interest may be made available to the customer in one or more useable forms. In one embodiment, the customer may obtain a printed form of a recipe(s), such as by interacting with the scale in some indicated manner (e.g., by touching or otherwise selecting a “Print” button) or by requesting a printout from a store employee. When a “Print” button 215 is provided for the customer, the button may appear on one or more of the display screens such as, for example, the initial recipe display screen and/or the recipe detail screen (as shown in FIG. 10).

In the case of printed recipes, the recipe(s) may print on a local printer in communication with the scale, on a remote printer in communication with the scale, or on a printer integral to the scale, such as on a label printer. Communication between a scale(s) and a printer(s) may be wired or wireless in nature. When sent to a remote printer, the printed recipe(s) may be obtained by the customer at an area of a store associated with or away from the scale, such as at a checkout location. Multiple scales can be networked or otherwise connected to a single printer to reduce system costs.

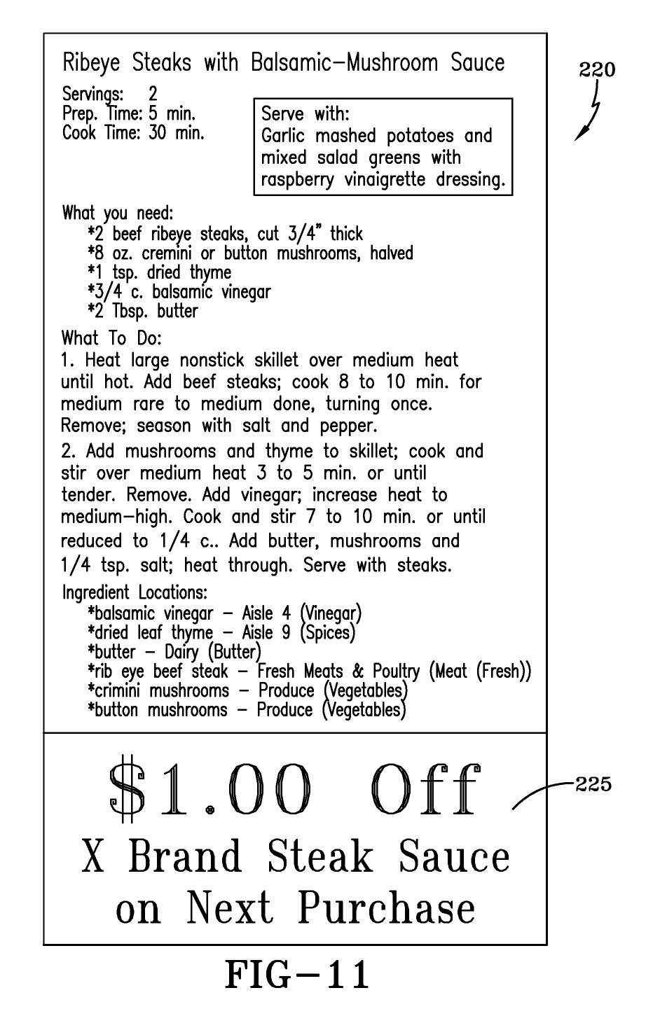

One exemplary embodiment of a recipe printout 220 is illustrated in FIG. 11. According to the present invention, such a recipe printout may be of varying appearance and content, may be printed in color and/or black and white, and may or may not include graphics (such as a recipe photo, etc.). A recipe printout according to the present invention may also include ancillary information that is, or is not, related to the printed recipe. Such ancillary information may include, for example, a coupon(s) 225 for one one or mor products. Such a recipe printout may be of virtually any size. More than one recipe may appear on a single printout.

In another embodiment of the present invention, a recipe(s) may be transmitted to a customer's e-mail account. In this case, the customer may enter an e-mail address into the scale or may provide an e-mail address to a store employee. E-mail account information may also be provided via a customer card or other customer information storage medium associated with the store and scanned or otherwise examined by the scale or another device associated with the scale. A recipe(s) may be e-mailed to a customer in lieu of, or in conjunction with, providing the customer with a printed recipe(s). Other information may be e-mailed to the customer in conjunction with the recipe. Such information may include, for example, a cooking video related to the selected recipe, and/or one or more coupons (whether or not related to the e-mailed recipe).

In yet another embodiment of the present invention, a website URL may be provided to the customer, such as for example, on a printed label, on a recipe printout, and/or in an e-mail. The website URL may allow a customer to access a recipe(s) and/or other related content (e.g., cooking videos, coupons, etc.) via the Internet. A website URL may be provided to a customer instead of, or in conjunction with, providing the customer with a printed recipe(s) and/or e-mailed recipe(s).

Advanced weighing scales typically have a scale software application (scale application) that governs their operation and remains in control of various scale components to ensure that applicable legal for commerce restrictions are not violated. A recipe-displaying application of the present invention may be integral to the scale application. That is, the recipe application may constitute a portion of the scale application. In this case, the entire recipe application, or only a portion of the recipe application may reside on the scale. For example in one exemplary embodiment, the recipe program may reside on the scale while an associated database(s) of recipes resides remotely therefrom. In another exemplary embodiment, both the recipe program and an associated database(s) of recipes may reside on the scale. In yet another exemplary embodiment, different databases may be located on different scales of a multi-scale facility, with the databases being shareable between scales.

In alternative embodiments of the present invention, a recipe application of the present invention may be a secondary application that interacts with the scale application. In this case, the scale application may control the secondary recipe application in various ways, such as when the secondary application may run, where on the scale display the recipes may appear, etc. Obviously, the interaction of a secondary recipe application with the scale application can occur in various ways. One particular methodology for facilitating the interaction of a secondary software application (such as a recipe application) with a scale application is described in detail in U.S. application Ser. No. 11/947,602, which was filed on Nov. 29, 2007, and is hereby incorporated by reference herein.

When the recipe application is a secondary application, the entire recipe application, or only a portion of the recipe application may once again reside on the scale. For example in one exemplary embodiment, both the recipe program and an associated database(s) of recipes may reside on the scale. In another exemplary embodiment, the recipe program may reside on the scale while an associated recipe database(s) of recipes resides remotely therefrom. In still another exemplary embodiment, the recipe program may reside remotely from the scale, with the associated recipe database(s) residing on or remotely from the scale. In yet another exemplary embodiment, different databases may be located on different scales of a multi-scale facility, with the databases being shareable between scales.

As described above and illustrated in the exemplary drawing figures, the present invention integrates the typical functions of an advanced weighing scale with various recipe functions. Thus, while it is possible for a customer to view and print (or have printed) recipes directly from such a scale, the scale still retains its normal functionality. For example, in conjunction with recipe information, the scale will still present the customer with typical PLU/SKU weight/price information. Thus, the present invention offers an integrated solution that automatically presents customers with recipes of interest, and eliminates the need for customers to deliberately seek out a separate device from which recipes must be specifically requested.

In light of the above description and the knowledge of one skilled in the art, it should be apparent that many variations of the exemplary display screens, their associated information, and/or their order of appearance are possible. Therefore, while certain exemplary embodiments of the present invention are described in detail above, the scope of the invention is not to be considered limited by such disclosure, and modifications are possible without departing from the spirit of the invention as evidenced by the following claims:

What is claimed is:

1. A weighing scale having recipe presentation functionality, comprising:
a weighing scale including a microprocessor, memory, one or more displays, and at least one input device;
a scale software application installed on said weighing scale and operative to govern scale operation;
a recipe software application associated with said weighing scale and operative to automatically present one or more recipes on said one or more displays of said weighing scale; and
a database of recipes associated with said recipe software application;
wherein one or more recipes are automatically presented to one or more users of said weighing scale during use thereof; and
wherein a user can subsequently select to receive one or more of said displayed recipes in one or more forms.

2. The weighing scale of claim 1, wherein said recipe software resides on said weighing scale.

3. The weighing scale of claim 1, wherein the functionality of said recipe software application is integrated as a function of said scale software application.

4. The weighing scale of claim 1, wherein said recipe software application is a separate program under the control of said scale software application.

5. The weighing scale of claim 1, wherein said database of recipes resides on said weighing scale.

6. The weighing scale of claim 1, wherein said database of recipes is located remotely from said weighing scale.

7. The weighing scale of claim 1, wherein at least some of the one or more recipes presented are related to a product being weighed or otherwise examined by said weighing scale.

8. The weighing scale of claim 1, further comprising a printer for printing recipes presented by said weighing scale.

9. The weighing scale of claim 8, wherein said printer is integral to said weighing scale.

10. The weighing scale of claim 8, wherein said printer is separate from but in communication with said weighing scale.

11. The weighing scale of claim 8, wherein said printer is shared by a plurality of said weighing scales.

12. An advanced weighing scale having automatic recipe presentation functionality, comprising:
an advanced weighing scale including a microprocessor, memory, one or more displays, and at least one input device;
a scale software application installed on said weighing scale and operative to govern scale operation;
a recipe software application installed on said weighing scale, said recipe software application operative to automatically select and present on said one or more displays of said weighing scale, one or more recipes related to a product being weighed or otherwise examined by said weighing scale; and
a database of recipes residing in said memory and accessible by said recipe software application;
wherein one or more recipes are automatically presented by said recipe software application to one or more users of said weighing scale upon identification of a product by/to said weighing scale; and
wherein a user can subsequently select to receive one or more of said displayed recipes in one or more forms.

13. The advanced weighing scale of claim 12, wherein the functionality of said recipe software application is integrated as a function of said scale software application.

14. The advanced weighing scale of claim 12, wherein said recipe software application is a separate program under the control of said scale software application.

15. The advanced weighing scale of claim 12, further comprising a printer for printing recipes presented by said weighing scale.

16. The advanced weighing scale of claim 15, wherein said printer is integral to said weighing scale.

17. The advanced weighing scale of claim 15, wherein said printer is separate from but in communication with said weighing scale.

18. The advanced weighing scale of claim 15, wherein said printer is shared by a plurality of said weighing scales.

19. A method of automatically displaying recipes on an advanced weighing scale, said method comprising:
providing an advanced weighing scale, said advanced weighing scale including:
a microprocessor, memory, one or more display devices, and at least one input device,
a scale software application installed on said weighing scale and operative to govern scale operation,
a recipe software application installed on said weighing scale, said recipe software application operative to automatically select and present on said one or more display devices of said weighing scale one or more recipes related to a product being weighed or otherwise examined by said weighing scale, and
a database of recipes residing in said memory and accessible by said recipe software application,
identifying a product of interest to/with said advanced weighing scale;
upon identification of said product of interest, causing said recipe software application to automatically select one or more recipes from said database of recipes and to present said one or more recipes on said one or more display devices of said advanced weighing scale, said one or more recipes related in some way to said product of interest;
allowing a user of said advanced weighing scale to select one or more of said presented recipes for subsequent delivery of said selected recipe(s) to said user; and
delivering said selected recipe(s) to said user in one or more forms selected by said user.

20. The method of claim 19, wherein a product of interest is identified by/to said advanced weighing scale using a technique selected from the group consisting of entering a PLU code, entering a SKU code, scanning a barcode, and selecting said product of interest from a list of possible products.

21. The method of claim 19, wherein said selected recipe(s) is delivered to said user by one or more of providing a printout, transmitting an email message, and providing a website URL.

22. The method of claim 19, further comprising the delivery of ancillary information to said user in conjunction with said selected recipe(s), said ancillary information related in some way to said selected recipe(s).

23. The method of claim 19, wherein said one or more recipes are presented on said one or more displays along with additional information relating to said product.

24. The method of claim 19, wherein at least one of said one or more display devices of said advanced weighing scale is a touchscreen, and wherein a user may manipulate and select a recipe(s) by interaction with said touchscreen.
